(19) United States
(12) Patent Application Publication
(10) Pub. No.: US 2005/0194319 A1
(43) Pub. Date: Sep. 8, 2005

(54) Ion exchange process

(76) Inventor: Paul Wegner, San Carlos, CA (US)

Correspondence Address: BENASUTTI, P.A., 17294 BERMUDA VILLAGE DRIVE, BOCA RATON, FL, 33487, US

(21) Appl. No.: 11/073,875

(22) Filed: Mar. 7, 2005

Related U.S. Application Data
(60) Provisional application No. 60/550,485, filed on Mar. 8, 2004.

(51) Int. Cl. C02F 1/42

(52) U.S. Cl. 210/670

(57) ABSTRACT

An ion exchange process for treating waste water having caustic materials, uses a bed of cation exchange resin beads to which the waste water is added. Thereafter the bed of beads is allowed to absorb the caustic materials in a brine until the resin is exhausted. The bed having retained organic matter is regenerated by rinsing the bed with water to remove substantially all the organic matter; draining any remaining rinse water; adding water and allowing it to pass through the bed and exit therefrom; mixing the exiting water with acid to form a dilute acid; and adding this dilute acid to the bed until the water exiting the bed has substantially the same pH as the dilute acid entering the bed.

### CROSS REFERENCE TO RELATED APPLICATION

This application is a continuation-in-part of my prior provisional patent application No. 60/550,485, filed Mar. 8, 2004, entitled “Ion exchange process”; the disclosure of which is incorporated herein by reference as if fully set forth; and a claim is hereby made for the benefit of the filing date of that application.

### BACKGROUND OF THE INVENTION

Prior Art

Most food processing industries are required to clean their processing equipment and surrounding areas at regular time intervals with hot and highly alkaline materials, such as sodium hydroxide, sodium carbonate, potassium hydroxide and potassium carbonate. For example, the dairy and meat industries require frequent and thorough cleaning of equipment. This is known as CIP waste (clean in place). These cleaning agents are used to hydrolyze proteins and fats; which converts them into soluble form. The resulting waste material is too alkaline for direct disposal to the sewer. Therefore, acid is added to adjust the pH to an acceptable level. The resulting salt level is often too high for discharge.

Presently salt level requirements are being meet by dilution with fresh water or by concentrating the waste material through evaporation or reverse osmosis. The concentrated waste material is then disposed of as hazardous waste.

In addition, the waste may contain high levels protein and fat which are difficult for water treatment facilities to convert to harmless gases such as carbon dioxide and nitrogen.

Normally removing high levels of salt from waste water by ion exchange is impractical, due to the high cost of regeneration chemicals.

In addition, ion exchange resins can blind in the presence of fat and protein.

The available technologies require expensive equipment, large amounts of power, and are expensive to maintain. Other approaches, such as dilution with fresh water, are impractical over the long run.

### SUMMARY OF THE INVENTION

It desirable to have a simple, cost effective means to remove caustic materials, fat and protein from a waste stream and produce purified, concentrated salable products which are removed from the waste stream.

The present invention uses chemical and thermal energy already provided by CIP (Cleaning In Place) procedures. Both caustic and acid (the two key chemicals involved an ion exchange cycle) are already provided in CIP processes. Normally, the CIP process leaves behind highly caustic waste. Therefore, sulfuric acid was used to bring the material back up to normal.

Dilute caustic material is readily and efficiently absorbed by cation exchange resins, such as Purolite C 104 or C 106. These resins are plastic beads chemically bonded with acid. Caustic material or caustic as used herein after means a group of alkaline materials selected from the group consisting of sodium hydroxide, potassium hydroxide, sodium carbonate and potassium carbonate.

The concentrated sulfuric acid which is usually used for the pH adjustment of the caustic waste stream can be used to regenerate the exhausted ion exchange resin. In addition, this approach allows one to selectively remove caustic sodium or potassium ions from the waste stream.

The exhausted resin bed may be washed with water before regeneration to remove any traces contaminants. When the resin is regenerated with acid, pure concentrated salt brine is produced. The brine is so concentrated that salt crystals precipitate out on cooling.

### DESCRIPTION OF THE DRAWINGS

FIG. 1 is a schematic of one embodiment of an apparatus for performing my process;

FIG. 2 is a schematic of one embodiment of an apparatus for performing my process;

FIG. 3 is a schematic of one embodiment of an apparatus for performing my process;

FIG. 4 is a schematic of one embodiment of an apparatus for performing my process;

FIG. 5 is a schematic of one embodiment of an apparatus for performing my process; and

FIG. 6 is a schematic of one embodiment of an apparatus for performing my process.

### DETAILED DESCRIPTION OF THE INVENTION

I let the ion exchange resin absorb all of the caustic out of the water and then when I need to regenerate the ion exchange bed, I use the acid. For example, a cation exchange resin may be in the form of cross-linked polyacrylic acid; which upon reaction with a base (such as, potassium hydroxide—that is, lye) yields a salt (potassium ((cross-linked)) polyacrylate) and water. I then add sulfuric acid to the ion bed to produce cross-linked polyacrylic acid and potassium sulfate. The resulting potassium sulfate salt may be displacement washed from the resin bed.

The salt removal system works the best on fresh CIP waste where the level of caustic material, such as potassium or sodium hydroxide, is high. If, instead, it is allowed to sit over time, the caustic material hydrolyzes fat and protein to produce less alkaline salts of amino acids and fatty acids. It is more difficult to remove sodium or potassium from these salts.

The higher the caustic concentration is, the better the ion exchange resin works. Using potassium caustic material is preferred because potassium hydroxide and potassium carbonate are more alkaline than sodium hydroxide salts and, therefore, more easily removed by ion exchange. Also, the potassium salts produced during regeneration are much more valuable than sodium salts. For example, sodium sulfate sells for about $100 a ton, as compared to potassium sulfate which sells for $200 a ton for use as fertilizer. If potassium hydroxide is used, 80% of the cost can be recovered by selling the resulting potassium sulfate. Secondly, any potassium salt that is not removed by the ion exchange has less environmental impact than the corresponding sodium salt, because potassium is required by living plants and, therefore, it is easily removed from water by the plants when the resulting waste water is used as irrigation water.

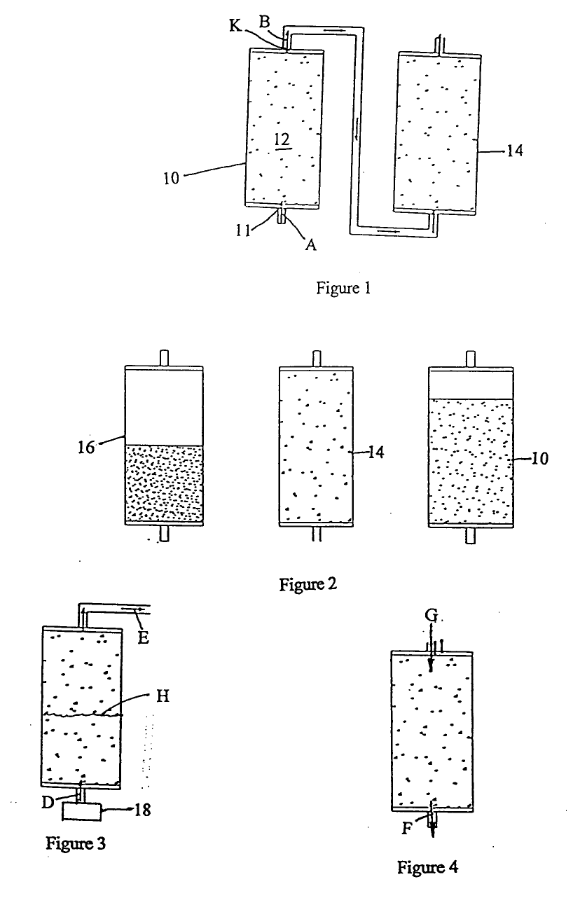

In one embodiment, I disclose a closed loop system. Therein, the ion exchange system consists of three beds in which two beds are removing caustic from the CIP waste and one bed is being regenerated or on standby. The beds are rotated in a musical chair fashion. Referring to FIG. 1, warm CIP waste is pumped in the direction of the arrow “A” through nozzles 11 at the bottom of the ion exchange bed 10 to fluidize the resin beads 12 and prevent channeling. The nozzles are preferably single orifice nozzles, such as would be found on a hose. The fluidization done by these nozzles is to get the whole bed to be fluid (like quick sand); so that it won't develop channeling cracks. The resin beads absorb the caustic as it flows through the fluidized bed. The more time the resin spends with the alkaline solution, the more caustic is removed.

It is important to fully exhaust the ion exchange bed before regeneration minimizes the chance of fat and protein sticking to the resin. By exhaust, I mean that virtually all the capacity of the resin has reacted to make potassium or sodium resin salt (such as, cross-linked potassium polyacrylate).

The CIP waste then flows in the direction of the arrows “B” through a second ion exchange (polishing) bed 14 to remove any caustic that the first bed does not absorb.

The first bed is considered exhausted when the pH of the stream entering the bed is similar to the pH of the stream leaving the bed as measured at “K” in FIG. 1. The resin is in a swollen state. At that point, the first bed is pulled out of service for regeneration. The second bed becomes the first bed and a freshly regenerated bed 16 (FIG. 2) becomes the second (polishing) bed 14 (FIGS. 1 and 2).

The exhausted bed 10 (FIG. 1) is regenerated in the following manner. Referring to FIG. 3, the exhausted bed is rinsed with water to remove all organic matter from the resin bed. Water with surfactants and caustic may be used to enhance the cleaning of the resin. Hot water is useful for melting away any fat. The rinse water is introduced by a pump 18 at the bottom of the bed in the direction of the arrow “D”. The waste stream from this phase of the process exits from the top of the bed in the direction of the arrow “E”, until organic waste is rinsed from the bed.

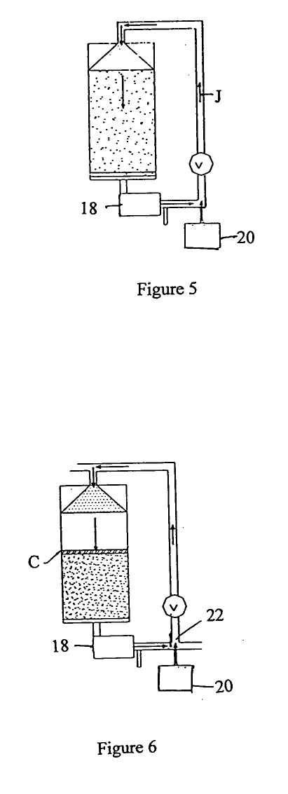

The resin bed is then drained of all water in the direction of the arrow “F”, FIG. 4; with just enough water remaining to maintain the prime of the re-circulation pump 18(FIG. 5).

Then the water is pumped from the bottom of the bed FIG. 5 and concentrated acid is added via the acid pump 20 and combined to produce a dilute acid stream “J”. This stream is introduced at the top of the bed.

The addition of acid is continued until the pH of the brine exiting from the bottom of the bed remains at about 2.

The resin shrinks during this process, such that at the end of this step, the brine level “C” is above the top of the resin. See FIG. 6. The produced brine is withdrawn from the bottom of the bed until the brine level is just below the top of the resin. The remaining brine is removed by displacement washing.

Fresh water is sprayed over the top of the resin bed and the brine level is maintained by pumping out brine at the same rate that the fresh water is introduced at the top of the bed. The brine is denser than water; therefore, as the brine diffuses out of the beads, it falls down to the level of similar salt concentration; in preference to mixing with the rinse water. Sufficient time is allowed for the brine to flow out of the resin beads and fresh water to diffuse into them. The rinse water is introduced at a rate of 0.2 to 2 bed volumes per hour. This is much slower than the recommended rinse rate of 4 to 40 bed volumes per hour. Over 95% of the brine is removed with approximately 0.5 bed volumes of rinse water. Over 99% of the salt is removed with less than one bed volume of rinse water. The high efficiency of washing yields a much more concentrated brine stream than produced by prior art regeneration methods. The displaced brine is collected. In some cases it is so concentrated that salt crystals precipitate out on cooling. The salt purity is high because substantially all the organic matter is washed out before regeneration begins.

The rinsing is continued until the desired amount of salt is washed away from the bed. The bed chamber is then filled with water and placed on standby.

In an alternate embodiment, I developed another high efficiency regeneration method that is gravity assisted regeneration. In this new method, a very concentrated, high density regeneration chemical is introduced at the top of the bed and slowly progresses down through the ion exchange bed by gravity.

The present invention comprises:
1) Switching to CIP cleaning chemicals from sodium to potassium, to produce high valve byproducts, such as potassium sulfate;
2) Taking advantage of the unique situation of chemicals present in CIP waste and neutralization chemicals which make the use of ion exchange commercially practical;
3) The use of nozzles to fluidize the resin bed, instead of diffuser plates;
4) The use of exhaustion and washing procedures before regeneration; which makes the use of ion exchange practical in the presence of fat and protein;
5) Draining the bed before regeneration to maximize brine concentration (this can dramatically reduce concentration, transportation, and disposal costs). In some cases the brine is pure and concentrated enough to be sold as a direct product with no further concentrating required;
6) The use of closed loop recirculation of water during regeneration, such that the use of concentrated regeneration chemicals (such as acid, caustic, or salt) can be used while the resin is only exposed to a dilute regeneration chemical to produce a high concentration of brine product; and
7) The use of very slow flow gravity assisted displacement washing to efficiently remove the salt from the resin bed.

A one liter ion exchange resin bed typically consist of 300 ml of drainable water, 450 ml of water retained by resin beads, and 250 ml occupied by the resin itself. If the regeneration chemical was uniformly distributed in the drainable and retained water, one would expect at least 750 ml of rinse water would be needed to displace most of the salt off the resin bed. Use of the present invention indicates removal of 99% of the salt brine with only 500 ml to 600 ml of rinse water.

If a 40 grams of regeneration chemical is applied, one would expect a maximum chemical concentration of 5%. However, experiments indicate a concentration as high as 12%. If one calculates expected regeneration chemical concentration based on drainable water (void volume i.e. the space between the beads) it comes to 13% which is close to the experimental value of 12%.

Another test demonstrated that the progression of regeneration is primarily driven by gravity. When 100 ml of a 40% salt brine regeneration chemical is applied to the top of a one liter resin bed over a 20 minute period, the salt concentration of the liquid leaving the bottom of the bed is 1.8%. Normally one would expect very little, if any, salt to occur until 300 ml of liquid had passed (the void volume of drainable liquid).

| | |
|---|---|
| Salt | |
| concentration of first 100 ml in ppm | Time of displacement in minutes |

| | |
|---|---|
| 18,000 | 40 |
| 2,620 | 20 |
| 1 | 5 |

When 300 ml has passed through over 50% of the regeneration chemical has been displaced off the resin bed. Thus the concentrated brine diffuses to the bottom of the bed to produce at regeneration concentration gradient where the highest regeneration chemical concentration (and density) is at the bottom of the column.

This means that regenerating by draining the bed first with just enough liquid to pump the liquid back to the top of the bed and slowly adding 100% regeneration chemical to produce a dilute regeneration stream allows for gentle regeneration conditions, while building up a very concentrated waste brine with each pass. The liquid is introduced by spray nozzle to insure uniform distribution. Once the required amount of regeneration chemical is added and time for equilibrium is completed, one can displaced the concentrated brine by reducing the brine waterline just below the top of the resin. The introduction of rinse water as spray and removal of brine from the bottom of the bed at the same rate, allows efficient removal of the brine from the resin bed with minimal dilution.

This regeneration method applies to the regeneration of ion exchange beds including water softening, acid removal, caustic removal, nitrate removal, and perchlorate removal.

### EXAMPLE 1

A one liter exhausted water softening bed is regenerated in the follow manner. The bed is drained until 240 ml of liquid remains. The liquid is pumped through rock salt (116 gram sodium chloride) to produce a saturated brine. The brine is sprayed on the top of the bed. This is continued until all the salt has dissolved. The volume brine of will increase to 300 ml. The sodium exchanges for the calcium to produce a concentrated calcium chloride brine (37% by weight). If 600 ml is used to displaced the brine off the column, 19% brine is produced.

### EXAMPLE 2

A one liter exhausted water softening bed is regenerated in the follow manner. The bed is drained until 100 ml liquid remains. The liquid is pumped through a mixing T fitting 22, FIG. 6 where concentrated hydrochloric acid (37%) to produce a dilute acid 1%. The dilute acid is sprayed on the top of the bed. This is continued until 200 ml has been added. The volume of resulting calcium chloride brine will increase to 300 ml. The hydrogen exchanges for the calcium to produce a concentrated calcium chloride brine (37% by weight). If 600 ml is used to displaced the brine off the column, 19% brine is produced.

Even less liquid can be used, but the degree of regeneration maybe reduced.

From what I have described it will be appreciated to those of skill in this art that I have invented an ion exchange process for treating waste water having caustic materials, comprising:
a. providing a bed of cation exchange resin beads;
b. introducing the waste water to the bed;
c. allowing the resin to absorb the caustic materials until the resin is exhausted; said bed having retained organic material;
d. rinsing off the retained organic material from the bed with a fluid; and then
e. regenerating the resin bed.

I have also invented a process of wherein the regenerating step “e” further comprises: rinsing the bed with a fluid selected from the group consisting of: water, water containing caustic, and water containing surfactants, to remove substantially all the retained organic matter.

Further, I have invented a process of regenerating an ion exchange a bed having a top and a bottom and fluid therein, comprising:
a. draining the majority of fluid from the bed;
b. pumping any remaining fluid from the bottom of the bed;
c. adding a water free, saturated, concentrated solution of regeneration chemicals to the pumped fluid to create a dilute regeneration chemical stream;
d. introducing the chemical stream at the top of the bed until the bed is regenerated and a brine remains; and then
e. introducing rinse water at the top of the bed to displace the brine at a rate of approximately 0.2 to 2 volumes of the bed per hour; and removing the resulting rinsed brine product at an approximately equal rate to the introduction of the rinse water in this step.

In this process I found it advantageous to remove the brine product in step “e” until the fluid level in the bed is at approximately or below the level of the resin in the bed.

It is further advantageous to introduce the rinse water as a spray.

I have also invented a process of regenerating an ion exchange a bed having a top and a bottom and fluid therein, comprising:
a. introducing a saturated solution of regeneration chemicals at the top of the resin bed;
b. adding displacement water at a rate of approximately 0.2 to 2 bed volumes per hour to form a displaced brine; and
c. collecting the displaced brine from the bottom of the bed.

In this process I found it advantageous to remove the fluid from the bed to a level at approximately or below the level of the top of the resin in the bed, before the introduction of a saturated solution of regeneration chemicals at the top of the resin bed in step “a”.

I have further invented a an ion exchange process for treating waste water having caustic materials, comprising: providing a bed of cation exchange resin beads; introducing the waste water to the bed at a rate which fluidizes the bed; allowing the beads to absorb the caustic materials; and then discharging the resulting brine.

This process further comprises regenerating the bed having retained organic matter by:
a. rinsing the bed with water to remove substantially all the organic matter;
b. draining any remaining rinse water;
c. adding water and allowing it to pass through the bed and exit therefrom;
d. mixing the exiting water with acid to form a dilute acid;
e. adding this dilute acid to the bed until the water exiting the bed has substantially the same pH as the dilute acid entering the bed.

1. An ion exchange process for treating waste water having caustic materials, comprising:
a. providing a bed of cation exchange resin beads;
b. introducing the waste water to the bed;
c. allowing the resin to absorb the caustic materials until the resin is exhausted; said bed having retained organic material;
d. rinsing off the retained organic material from the bed with a fluid; and then
e. regenerating the resin bed.

2. The process of claim 1 wherein the regenerating step “e” further comprises: rinsing the bed with a fluid selected from the group consisting of: water, water containing caustic, and water containing surfactants, to remove substantially all the retained organic matter.

3. The process of regenerating an ion exchange a bed having a top and a bottom and fluid therein, comprising:
a. draining the majority of fluid from the bed;
b. pumping any remaining fluid from the bottom of the bed;
c. adding a water free, saturated, concentrated solution of regeneration chemicals to the pumped fluid to create a dilute regeneration chemical stream;
d. introducing the chemical stream at the top of the bed until the bed is regenerated and a brine remains; and then
e. introducing rinse water at the top of the bed to displace the brine at a rate of approximately 0.2 to 2 volumes of the bed per hour; and removing the resulting rinsed brine product at an approximately equal rate to the introduction of the rinse water in this step.

4. The process of claim 3 further comprising the step of removal of the brine product in step “e” until the fluid level in the bed is at approximately the level of the resin in the bed.

5. The process of claim 3 in which the rinse water is introduced as a spray.

6. The process of claim 3 further comprising the step of removal of the brine product in step “e” until the fluid level in the bed is below the level of the resin in the bed.

7. The process of regenerating an ion exchange a bed having a top and a bottom and fluid therein, comprising:
a. introducing a saturated solution of regeneration chemicals at the top of the resin bed;
b. adding displacement water at a rate of approximately 0.2 to 2 bed volumes per hour to form a displaced brine; and
c. collecting the displaced brine from the bottom of the bed.

8. The process of claim 7 wherein the fluid is drained from the bed to a level at approximately the level of the top of the resin in the bed, before the introduction of a saturated solution of regeneration chemicals at the top of the resin bed in step “a”.

9. The process of claim 7 wherein the fluid is drained from the bed to a level below the level of the top of the resin in the bed, before the introduction of a saturated solution of regeneration chemicals at the top of the resin bed in step “a”.
